(19) United States
(12) Patent Application Publication
(10) Pub. No.: US 2012/0233927 A1
(43) Pub. Date: Sep. 20, 2012

(54) CONNECTING ASSEMBLY FOR CONNECTING A DRIVING DEVICE TO A HINGED MEMBER OF A MOTOR VEHICLE AND DRIVING DEVICE COMPRISING THE SAME

(75) Inventor: Uwe Sommer, Effelder (DE)

(73) Assignee: BROSE FAHRZEUGTEILE GMBH & CO. KG, HALLSTADT, Hallstadt (DE)

(21) Appl. No.: 13/512,738

(22) PCT Filed: Dec. 1, 2010
(86) PCT No.: PCT/EP2010/068655

§ 371 Date: May 30, 2012

(30) Foreign Application Priority Data
Dec. 4, 2009 (DE) 20 2009 016 434.9

(51) Int. Cl. F16C 35/00; E05F 15/04

(52) U.S. Cl. 49/358; 384/428

(57) ABSTRACT

The invention relates to a connecting assembly for connecting a driving device (100) to a hinged member of a motor vehicle, in particular to a pivotably hinged ventilator window. The driving apparatus adjusts a hinged lever (6), at the front free end (60) thereof there is formed an adjustment point (61), together with a coupling member (3) which is connectable to the hinged member, and together with a bearing shell (4), which is positively accommodated in the coupling member (3) and pivotably supports the adjustment point (61).

To accomplish the necessary motion compensation during the adjustment of the hinged lever and a compensation of tolerances, according to the invention the adjustment point (61) is pivotably supported in the bearing shell (4) about an axis (B) perpendicular to the longitudinal axis of the hinged lever and the bearing shell is rotatably received in the coupling member (3) about its longitudinal axis (A) and perpendicular to the axis (B). By means of this simple assembly, two mutually perpendicular axes can be precisely defined in a simple manner. Overall, according to the present invention the hinged lever can thus be rotated about two mutually perpendicular axes.

The present application claims priority from German Utility Model Application No. 20 2009 016 434.9 ‘Connecting assembly for connecting a driving device to a hinged member of a motor vehicle and driving device comprising the same’, filed on 4 Dec. 2009, the entire content of which is explicitly incorporated by way of reference for disclosure purposes.

### FIELD OF THE INVENTION

The present invention relates generally to connecting a driving device with a hinged member of a motor vehicle, preferably a pivotable side window or hinged window disposed in the rear area provided of a motor vehicle, and particularly relates to a connecting assembly for this purpose.

### BACKGROUND OF THE INVENTION

From German utility model DE 20 2008 003 169 U1 of the applicant, a driving device for such a hinged member is known, as shown in the example of FIG. 1. The driving device 100 comprises an electric motor 101, on the drive shaft 102 of which a stationary worm 103 is seated which meshes with a worm wheel 104, which drives a downstream reduction gear 105, which drives the drive wheel 106. The drive wheel 106 moves the hinged lever (push-out lever) 110 via the driving arm 107 and the integrally formed guide fork 108, wherein the front free end of the lever 111 is connected or coupled via a connecting assembly (not shown) with the hinged member (not shown), for displacing the hinged member along a displacement path. The roller 109, which acts as a point of articulation of the hinged lever 110, is thus guided in the guide fork 108. Thus, upon rotation of the drive wheel 106 the hinged lever 110 is moved substantially along the straight line shown schematically.

A connecting assembly according to the preamble of claim 1 is disclosed in DE 10 2004 052 275 A1 and comprises a coupling member that can be attached to a flange of a side ventilator window via a screw received in the bottom of the coupling member, and a bearing shell formed by two bearing halves, which is positively accommodated in the coupling member and pivotably supports the adjustment point provided at the front end of the hinged lever. The front free end of the hinged lever is formed as a ball flattened on both sides and with a predetermined width. The two bearing halves embrace the flattened ball at the front end of the hinged lever in a form-fitting manner, in the manner of a ball joint, so that the hinged lever can rotate relative to the coupling member about two mutually perpendicular axes, which enables on the one hand a tolerance compensation and on the other hand the necessary motion compensation for the hinged lever while displacing the hinged member.

The coupling member comprises an opening for receiving the front free end of the hinged lever the width of which is slightly greater than the width of the flattened ball at the front end of the hinged lever and is smaller than the ball diameter of the flattened ball. In this way, the push-out lever can be inserted into the bearing shell in a position rotated by 90° and can subsequently be rotated by 90° to assume the operating state. The width of the afore-mentioned opening of the coupling member is, on the other hand, smaller than the diameter of the flattened ball at the front end of the hinged lever or push-out lever, so that the push-out lever cannot be brought out axially from the coupling member in the operating position, but is axially secured.

The ball joint-like connection or coupling may fail, however, at high temperatures such as these may easily prevail in the interior of a motor vehicle in summertime, or under greater forces, for example in the event of a burglary. Furthermore, the configuration of the connecting assembly is relatively complicated, resulting in higher costs for the assembly of the connecting assembly. For tolerance compensation purposes and as protection against rattling particular damping elements in the area of the ball joint are mandatory, which further increases the costs and efforts.

### SUMMARY OF THE INVENTION

It is an object of the present invention to further enhance a connecting assembly of the generic type to the extent that it can be produced and mounted easier and in a more cost-effective manner, and enable an anti-rattle-effect and compensation of tolerances as well as a motion compensation in a simple but effective manner. According to another aspect of the present invention a corresponding driving device shall be provided with such a connecting assembly for coupling to a hinged member to be adjusted.

According to the present invention these objects are achieved by a connecting assembly having the features of claim 1, and by a driving device having the features of claim 15. Further advantageous embodiments are the subject-matter of the dependent claims.

According to the present invention the adjustment point is pivotably supported in the bearing shell at the front end of the hinged lever about an axis perpendicular to the longitudinal axis of the hinged lever. Furthermore, the bearing shell is accomodated in the coupling member so that it is pivotable about a second axis, namely about its longitudinal axis and perpendicular to the afore-mentioned axis. Unlike a ball joint associated with the adjustment point, which may be suitably formed, and with the bearing shell, which is rotatably accommodated in the coupling member, two well-defined elements are available that can be rotatably mounted respectively in a precise manner and mechanically stable for themselves. By means of these elements, which can be formed easily, according to the present invention two mutually perpendicular axes can be precisely defined in a simple manner. Overall, the hinged lever can thus be rotated according to the present invention about two mutually perpendicular axes, on the one hand to thereby enable the necessary motion compensation during the adjustment of the hinged lever and on the other hand to thereby enable a tolerance compensation.

In this case, the coupling member, bearing shell receiving the coupling piece and, if necessary, a base coupled with the hinged lever can be made of suitable plastic materials, in particular by injection molding, so that the connecting assembly according to the present invention, on the one hand, is sufficiently stable and, on the other hand, is sufficiently resilient to accomplish a tolerance compensation over the range of operating temperatures, and quite particularly preferably also without using additional elastic damping elements.

In order to enable a defined interface for rotatably mounting of the front free end of the hinged lever about said afore-mentioned axis in the bearing position, the afore-mentioned axis is defined on the adjustment point and within or on the bearing shell, preferably by the cooperation of cylindrical form-fitting elements. To this end, according to another embodiment cylindrical projections or recesses may be provided at the front free end of the hinged lever, in particular two cylindrical projections or recesses symmetrically formed on both sides of the hinged lever, which cooperate positively with correspondingly formed recesses or projections within or on the bearing shell. In accordance with the present invention a stable engagement can be accomplished that enables a high mechanical stability and reliability of the connection or coupling. In particular, the adjustment point can be formed as a bearing bolt or bearing busing at the front end of the hinged lever, which cooperates with correspondingly shaped bearing portions within the bearing shell such that the hinged lever is rotatably supported in the bearing shell about the afore-mentioned axis. The bearing bolt or bearing bushing thereby precisely defines an axis of rotation within the bearing shell.

According to a further embodiment, the bearing shell is formed by two bearing halves of a plastics material, which together form a bearing portion for rotatably or pivotably supporting the adjustment point about the aforesaid axis. Preferably, this bearing portion has a cylindrical shape, for forming bearing bolts or bearing rollers, which are formed at the front free end of the hinged lever.

Preferably, the bearing halves are formed identical and are configured such that they can be coupled together, each mirror-inverted to each other, to thereby form the afore-mentioned bearing portion. Preferably the two bearing halves are latched to this end, particularly by means of suitable form-fitting structures which are provided on the bearing halves, for example by means of locking projections or recesses and correspondingly shaped latching recesses or projections.

According to a further embodiment, the two bearing halves can each be inserted into the coupling member via an insertion opening formed in the coupling member and perpendicularly to the longitudinal axis of the coupling member, particularly in order to be locked together. The insertion opening preferably extends completely and diametrically through the coupling member and thus defines an axis parallel to the longitudinal axis of the bearing shell or perpendicular to the longitudinal axis of the coupling member, about which axis the coupling member accommodated in the bearing shell can be rotated or pivoted.

Preferably, the coupling member comprises for this purpose a receptacle extending in the longitudinal direction of the coupling member, in which receptacle the bearing shell is positively accommodated and such as to be axially secured in the direction of the longitudinal axis of the coupling member, wherein the receptacle is open at its upper end for accomplishing an engagement of the adjustment point with the bearing shell.

In order to accomplish the afore-mentioned rotatable mounting of the bearing shell in the coupling member, the profile of the bearing shell formed by the two bearing halves preferably corresponds to the profile of the insertion openings and/or of the receptacle formed in the coupling member. At this occasion, stops within or on the coupling member and/or on the two bearing halves can define the position of the supporting portion for rotatably mounting the adjustment point in the bearing shell to enable a precise positioning.

According to a further embodiment, the connecting assembly further comprises a base fixedly connected or fixedly connectable to the hinged member to be adjusted. Preferably, the coupling member is detachably connectable to this base in the manner of a bayonet coupling. For this purpose, a form-fitting structure may be formed at the lower end of the coupling member and a correspondingly shaped interlocking structure may be formed on that side of the base facing the coupling member, which cooperate together in such a manner that the coupling member and the base may be brought into mutual engagement in a first rotational position and that the coupling between the coupling member and the base can be accomplished by a simple rotation of the coupling member together with the hinged lever about a longitudinal axis thereof.

Suitably, the afore-mentioned form-fitting (positive locking) structures comprise for this purpose a plurality of form-fitting elements that cooperate with each other in a suitable manner, in order to lock the coupling member to the base. In particular, the form-fitting elements are locking projections or locking recesses, which are preferably identical and which are preferably formed symmetrically to each other on the coupling member or base, which cooperate with correspondingly shaped locking projections or locking recesses.

To enable a compensation of mechanical tolerances over the entire range of operating temperatures, according to another embodiment a circumferential bearing surface can be formed at the upper rim of the base for supporting an elastic sealing ring which is held clamped between the coupling member and the base in the assembled state, when the coupling member is coupled to the base, in particular latched to the base. By suitable dimensioning of the sealing ring and those sides of the coupling member and of the base facing to each other, such a compensation of tolerances can be easily accomplished by the deformation of the sealing ring.

Suitably, the afore-mentioned sealing ring is formed as a bead on the lower end of a sealing hood or sealing dome bell, which surrounds the coupling member and the front end of the hinged lever in the manner of a hood or dome and which is preferably formed rotationally symmetrical. In this embodiment two circumferential sealing lips can protrude from the peripheral edge of the sealing flap in radial direction, wherein a gap is formed between these sealing lips and wherein the sealing lips can engage in the edge of a mounting opening, for example an interior trim of a vehicle compartment or a mounting opening in a vehicle panel, to seal the connecting assembly.

As stated above, a further aspect of the present invention relates to a driving device for a hinged member of a vehicle, such as those exemplified and disclosed in the German utility model DE 20 2008 003 169 U1 of the applicant, the entire contents of which are hereby incorporate by way of reference for disclosure purposes, wherein the driving device comprises a connecting assembly according to the present application.

### OVERVIEW ON DRAWINGS

In the following the invention will be described by way of example and with reference to the accompanying drawings, from which further features, advantages, and problems to be solved will become apparent. In the drawings:

FIG. 1 shows a driving device according to the prior art, as this may in principle be used also according to the present invention;

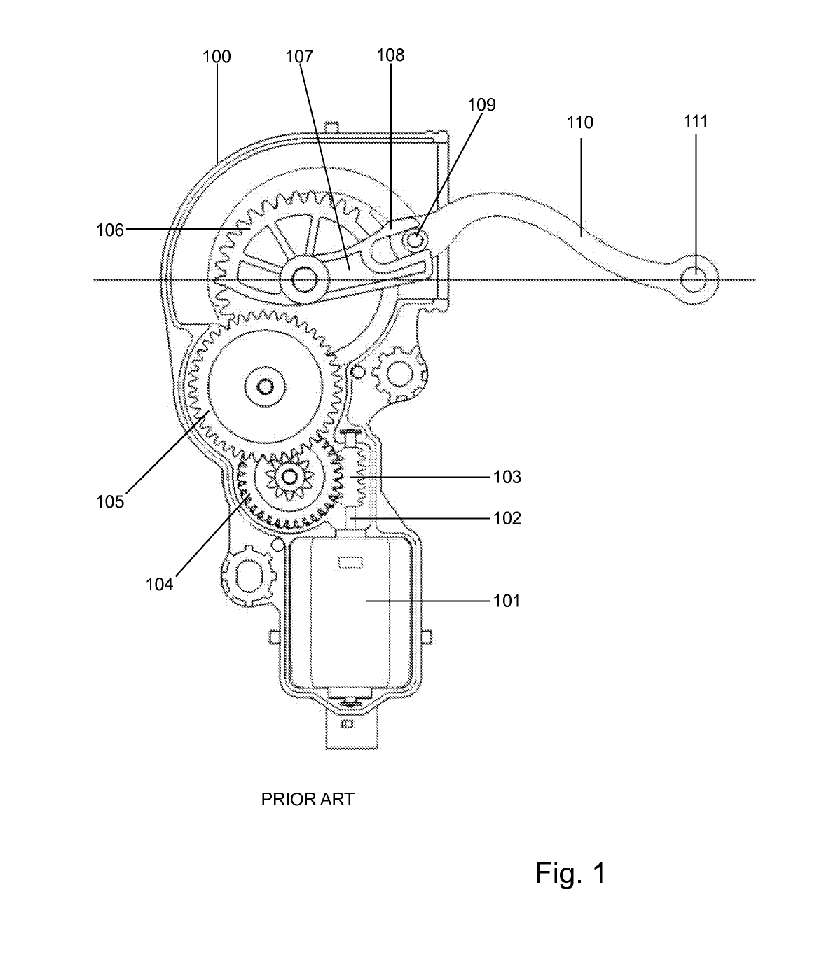

FIG. 2 shows in a schematic side view a connecting assembly according to the present invention;

FIG. 3 is a sectional view of the connecting assembly along A-A in FIG. 2;

FIG. 4 shows in an enlarged partial perspective view a bearing shell of the connecting assembly according to FIG. 3;

FIG. 5 shows in a perspective exploded view of a connecting assembly according to the present invention;

FIG. 6 shows a connecting assembly according to the present invention in a preassembled state and during an assembly for connecting or coupling with a base that is provided on the hinged member to be adjusted; and

FIG. 7 shows the connecting assembly according to the present invention in the operating state together with the base provided at the hinged member, wherein the mechanical degrees of freedom are shown.

In the figures, identical reference numerals designate identical or substantially equivalent elements or element groups

### DETAILED DESCRIPTION OF PREFERRED EMBODIMENTS

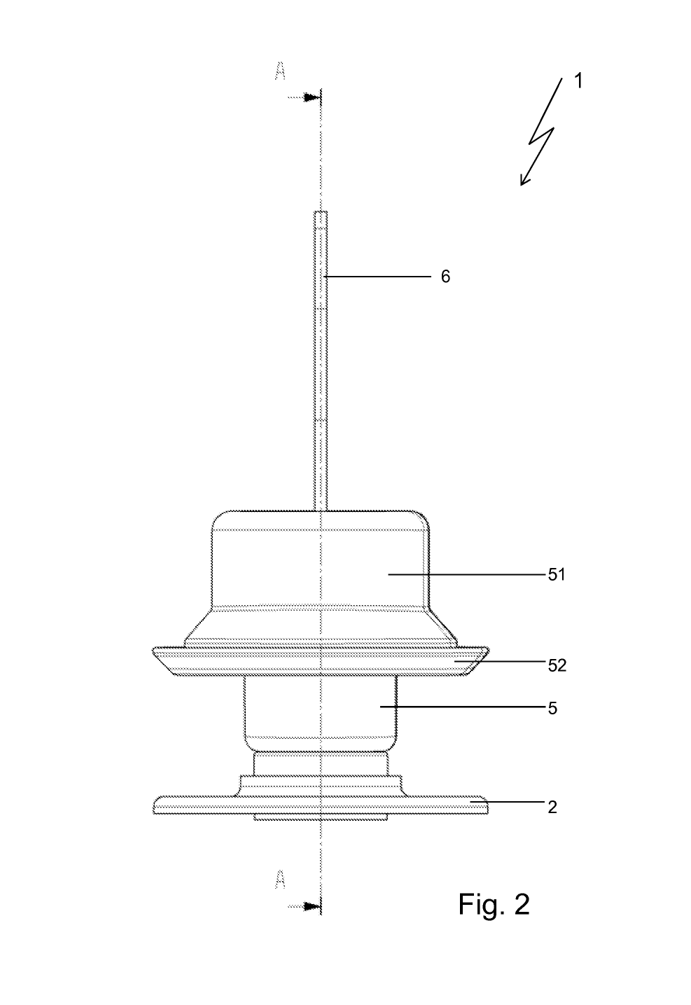

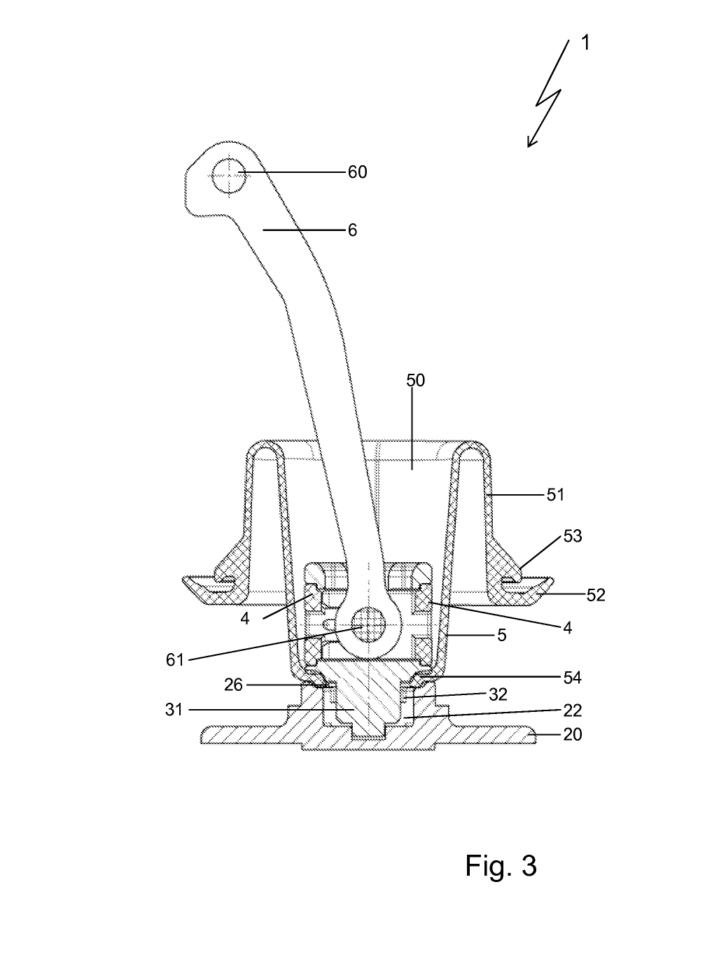

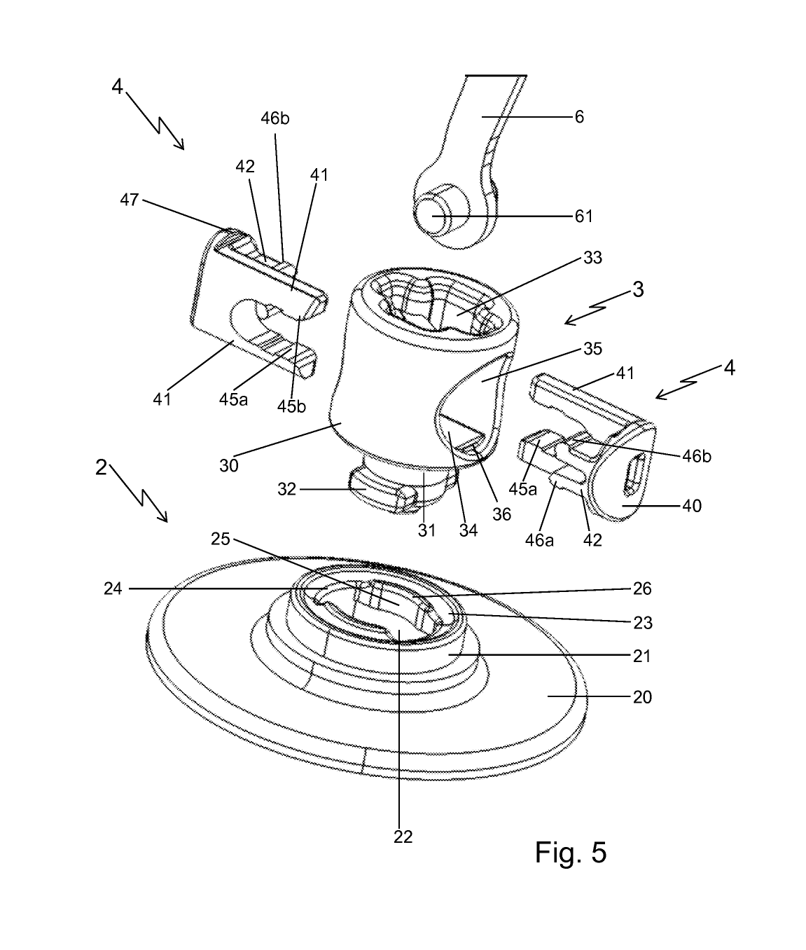

According to FIG. 2 and FIG. 5 a connecting assembly according to the present invention comprises a base indicated overall by the reference numeral 2, which is fixedly connected or fixedly connectable with the hinged member (not shown), particularly a one-sided hinged ventilator window which can be pushed out, a cylindrical coupling member, which is hollow on its inner side and is overall indicated by reference numeral 3 and two bearing halves, which are respectively indicated by reference numeral 4 and which can be locked together and can be rotated in the insertion opening 35 of the coupling member 3 about its longitudinal axis. The interlocked bearing halves 4 form a bearing portion for rotatably supporting the bearing bolt 61 at the front at the end of the hinged lever 6 so that the hinged lever 6 can be pivoted about the rotation axis formed by the two bearing bolts 61, i.e. perpendicular to the longitudinal direction of the two bearing halves 4 and perpendicular to the longitudinal direction of the coupling member 3, when the two bearing halves 4 are locked together and are accommodated in the receptacle 33 of the coupling member 3. As can be seen from FIGS. 2 and 3, the coupling member 3 is covered by a hood-shaped or dome-shaped sealing element 5, which overall is rotationally symmetrical.

According to FIG. 5, the coupling member is formed as a coupling sleeve 30 having an open upper end so that the front free end of the hinged lever 6 can be inserted from above into the cylindrical receptacle 33 formed in the coupling member 3, in order to engage into the bearing shell for accomplishing the afore-mentioned pivotable support. In the peripheral side wall of the coupling member 3 two insertion openings 35 are formed on diametrically opposite sides, which are preferably of a circular shape, through which the two bearing halves 4 can be introduced from the side, as set forth in more detail hereinafter. At the lower end of the coupling member 3 a cylindrical extension 31 is formed on which two diametrically opposite and radially projecting locking projections 32 are formed. The bottom 34 of the receptacle 33 of the coupling member 3 extending in the longitudinal direction is planar or is formed concavely curved, in correspondence to the profile of the bearing shell formed by the two bearing halves 4.

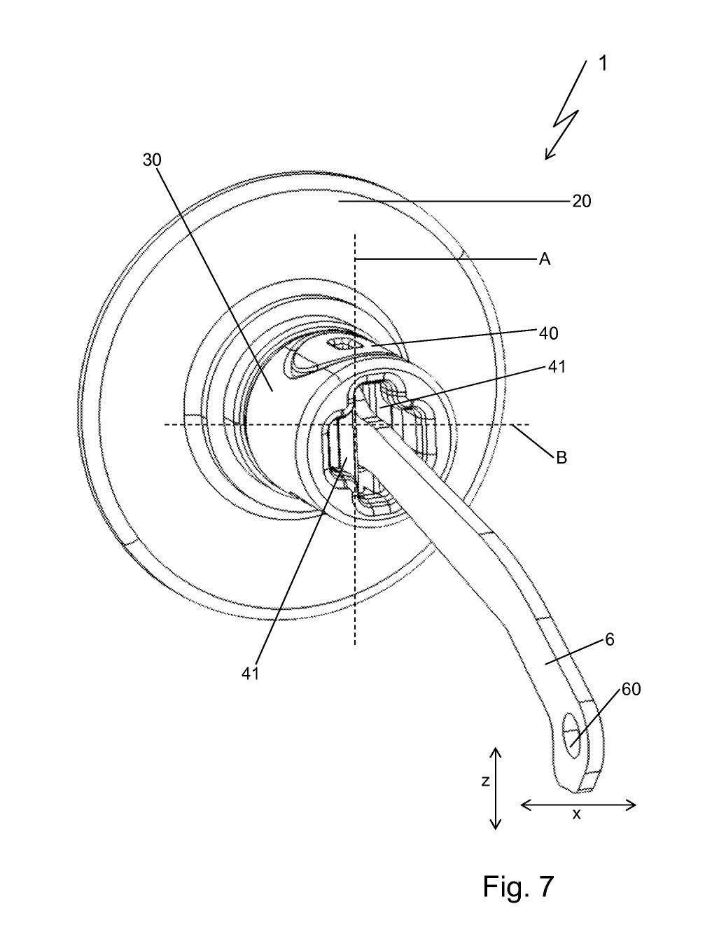

According to FIG. 5, the base 2 has a circular base plate 20, which is fixedly connected or can be fixedly connected to the hinged member to be adjusted, e.g. is glued on an inner side of the hinged member. From the top of the base plate 20 a cylindrical peripheral wall 21 protrudes axially and downwardly, in which a receptacle 22 is formed for insertion and locking of the locking projections 32 provided at the lower end of the coupling member 3. On the inner side of the cylindrical side wall 21 concavely curved bearing surfaces 25 are formed at two diametrically opposite sides, which abut to the locking projections 32 in the locking position of the connecting assembly according to the present invention (see FIG. 7). To secure the coupling member 3 in the locking position to the base 2 axially, at the upper end of the bearing surfaces 25 two locking projections 26 protrude radially into the receptacle 22, which are embraced by the locking projections 32 in the locking position for locking and axially securing them. The opening width of the receptacle 22 corresponds at least to the distance between the front ends of the diametrically opposite locking projections 32 of the coupling member 3. According to FIG. 5 a circumferential concave sealing element support 23 is formed at the upper end of the cylindrical side wall 21, which serves for receiving or supporting a sealing member, as more fully described below with reference to FIG. 3.

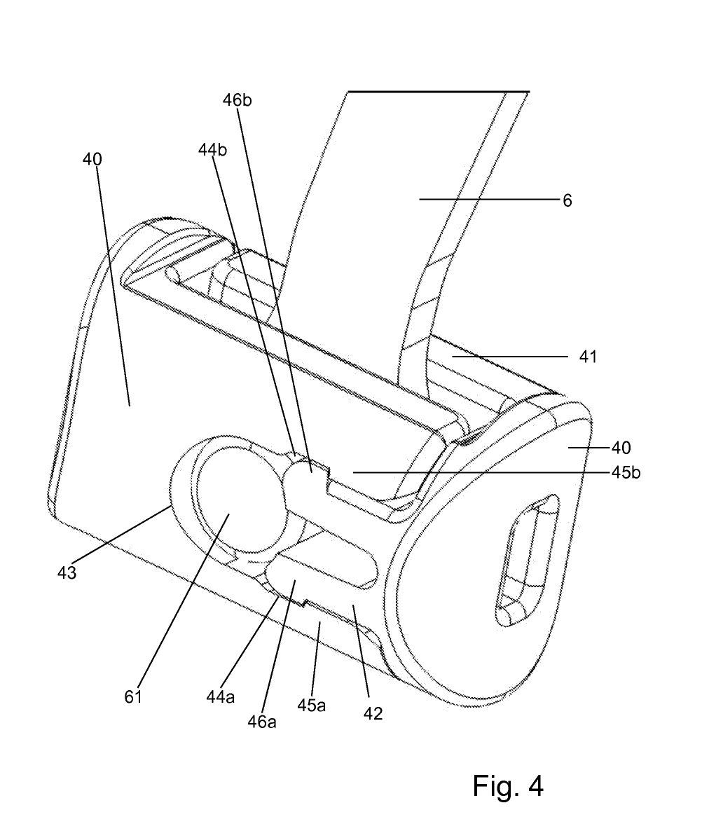

According to FIG. 4 and FIG. 5 the two clamp-like bearing halves formed 4 are of identical shape and can be pushed on one another, each mirror-inverted to each other, and locked together, as shown in FIG. 4. According to FIG. 5, the two bearing halves 4 comprise a base 40 from where the two bearing arms 41 project vertically. The two bearing arms 41 extend parallel to each other and spaced from one another to form an elongated hole, the bottom of which forms a semi-circular bearing portion 43. At the front end of the bearing arms 41, a hook-shaped latching tab 45a, 45b is formed, which joins with the rectangular recess 44a, 44b. As can be concluded from the right-hand part of FIG. 5, two securing arms 42 are formed laterally offset from the bearing arms 41, which also extend parallel to each other and spaced from one another and protrude perpendicularly from the base 40. The distance between the securing arms 42 is chosen so that these can be inserted into the elongated slot formed in the bearing arms 41 of the opposite, mirror-inverted bearing halves 4 to be latched, as shown in FIG. 4. For latching with the bearing arms 41 hook-like latching tabs 46a, 46b are formed at the front ends of the securing arms 42 which project laterally from the securing arms 42 and engage behind the locking tabs 45a, 45b of the opposite mirror-inverted bearing half 4 and are engaged into their locking recesses 44a, 44b.

According to FIG. 5, the two bearing halves 4 can be inserted, mirror-inverted to each other, into the coupling member 3 via the two insertion openings 35. For mounting the connecting assembly, beforehand the front end of the hinged lever or push-out lever 6 is inserted into the receptacle 33 of the coupling member 3 such that upon insertion of the two bearing halves 4 into the coupling member 3 the two mutually opposite bearing bolts 61 are embraced by the bearing arms 41 of the bearing halves 4. Upon further insertion of the two bearing halves 4 finally the front ends of the securing arms 42 and the bearing arms 41 of the opposite bearing half get in abutment to one another and these are bent elastically when the two bearing halves 4 are approached further, until finally the already above-described locking position according to FIG. 4 is reached, in which the respective bearing bolt 61 of the rounded front ends of the securing arms 42 are pressed against the circularly shaped bearing portion 43 of the two bearing arms 41 of the associated bearing half 4. In this position, the hinged lever 6 can be pivoted about the axis formed by the bearing bolt 61, which protrude symmetrically from the hinged lever 6.

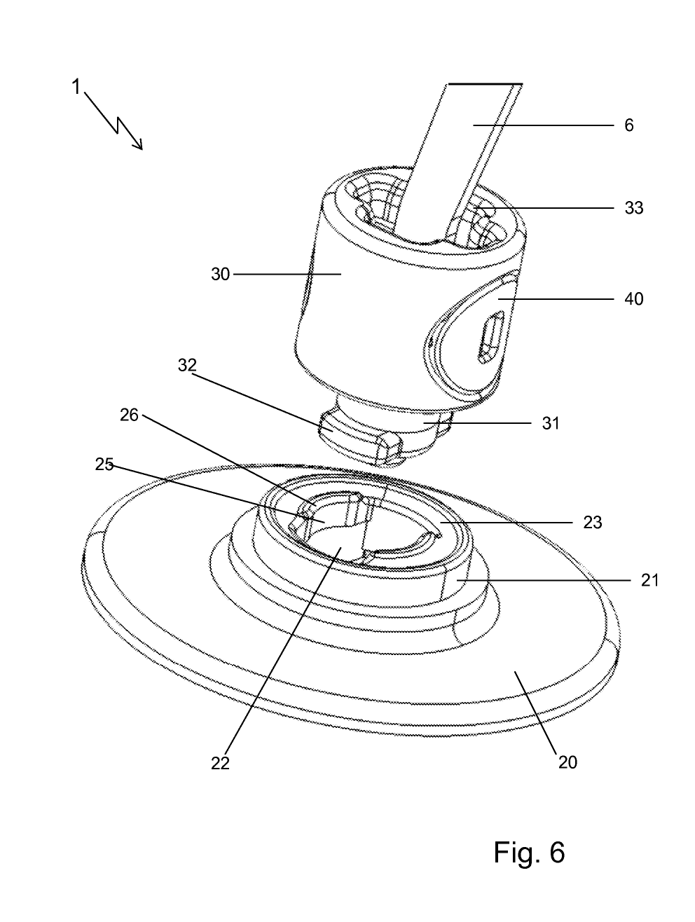

According to FIG. 6, the coupling member can be rotated such that the locking tabs 32 can be inserted 32 into the receptacle 22 of the base. Starting from the insertion position according to FIG. 6, the coupling member together with the bearing half, which is received therein and formed by the two afore-mention bearing halves, and the hinged lever 6, which is pivotally supported therein, can be rotated by 90°, so that the two guide protrusions 32 engage behind the locking protrusions 26 and the operating position shown in FIG. 7 is reached, in which the hinged lever 6 of the driving device (not shown) is connected to the base 20 via the coupling piece 30 and the bearing shell 40. In the operating position, the hinged lever 6 can be pivoted about the axis B, i.e. in the z-direction (for example in the vertical direction) for enabling a motion compensation upon adjustment of the hinged member, wherein the bearing shell 40 is received in the coupling member 30 in such a manner that it can be rotated about the axis A and that the hinged lever 6 can be rotated in the illustrated x-direction (for example in the vehicle longitudinal direction) for the necessary motion compensation.

According to FIG. 4, a longitudinal slot is formed between the bearing arms 41 of the two bearing halves in the locking position of the bearing shell, into which the front free end of the hinged lever 6 engages and is thus guided along a straight line. According to FIG. 5 two mechanical stops 36 are formed at the sides of the bottom 34 of the coupling member 3, which define, in cooperation with a stop 47 formed on the base 40 of the bearing halves 4, the position of the two bearing halves.

According to the FIGS. 2 and 3, the coupling sleeve 30 is surrounded by a dome-shaped or hood-like sealing grommet 5, which is generally rotationally symmetrical, wherein a circular peripheral bead 54 is formed at its lower end, which is clamped between the lower end of the cylindrical coupling sleeve 30 and the sealing seat 23 of the base 2. The bead 54 and preferably the entire grommet 5 is formed from a resilient rubber or plastic material. The clamping force for clamping of the bead 54 is given by the dimensioning of the bayonet-type locking structure formed by the cylindrical extension 31 with the radial latching protrusions 32 and the bearing surfaces 25 and securing projections 26 and can easily be selected such that, even without the aid of additional damping elements, a sufficient tolerance compensation and an adequate protection against rattling over the entire range of operating temperatures is ensured.

According to FIG. 3, the grommet is open at its upper end so that the hinged lever 6 can be inserted from above into the bearing shell 4 so as to be rotatably or pivotally mounted therein. From the outer surface 51 a sealing flap 52 protrudes in radial direction, two circumferential sealing lips 53 being formed on the sealing flap 52 and a gap being formed between the sealing lips 53, wherein the sealing lips 53 can be pushed onto the edge of a mounting opening in the vehicle body or in a vehicle interior trim of the vehicle interior to seal the connecting assembly against the vehicle interior.

For assembly of the connecting assembly according to the present invention one proceeds as follows: firstly, the hinged lever 6 of the driving device is connected or coupled to the coupling member 3 by inserting the two bearing halves 4 (see FIG. 5) into the coupling member 3 and by interlocking of the two bearing halves 4. In this state, the driving device is delivered. Here, the grommet (see FIG. 2) can already be loosely fitted onto the coupling member 3. On the side of the factory the connection or coupling to the socked provided on the hinged member is accomplished in the rotational position shown in FIG. 6, starting from which the coupling member with the hinged (push-out) lever and the driving device is rotated into the rotational position shown in FIG. 5, in which the coupling member 3 and the base 2 are locked together.

As the driving device in particular a driving device according to the German utility model DE 20 2008 003 169 U1 of the applicant may be used, the entire content of which is hereby incorporated by way of reference specifically for purposes of disclosure. Preferably, all components of the connecting assembly according to the present invention are inexpensive and made of suitable plastics, in particular by injection molding. For this purpose one may dispense with a costly two-component injection molding process. As compared to the prior art the connecting assembly according to the present invention can be manufactured with a lower overall height, which allows more freedom in the design of vehicle interior trims. As will become readily apparent to the person skilled in the art upon reading the foregoing description, a hinged member within the meaning of the present application may in particular be any pivotable, i.e. on one side hinged, openable closure member for closing an opening of a motor vehicle body, preferably a pivotable lateral window or ventilator window. In general, however, also an elevating roof, a cover, a hood or the like may be understood as such a hinged member.

### LIST OF REFERENCE NUMERALS

1 connecting assembly

2 base

3 coupling member

4 bearing shell

5 grommet

6 hinged lever

20 base plate

21 cylindrical side wall

22 receptacle

23 sealing sleeve support

24 insertion surface

25 contact surface

26 securing protrusion

30 coupling sleeve

31 extension

32 locking protrusion

33 receptacle

34 bottom

35 insertion opening

36 side stop

40 base

41 bearing arm

42 securing arm

43 bearing portion

44a/b lower/upper recess

45a/b lower/upper latch

46a/b lower/upper latch

47 stop

50 inner surface

51 outer surface

52 sealing flap

53 sealing lip

54 bead

60 front end of lever

61 bolt

100 driving device

101 electric motor

102 driving shaft

103 worm

104 worm wheel

105 reduction gear

106 drive wheel

107 driving arm

108 guide fork

109 roller

110 hinged lever

111 lever end

1. A connecting assembly for connecting a driving device to a hinged member of a motor vehicle, wherein
said driving device is configured for adjusting a hinged lever, and
an adjustment point is formed at a front free end of the hinged lever,
said connecting assembly comprising
a coupling member which is configured to be connected to the hinged member, and
a bearing shell, which is positively accommodated in the coupling member and pivotally supports the adjustment point, wherein
the adjustment point is supported in the bearing shell so as to be pivotable about an axis perpendicular to the longitudinal axis of the hinged lever and
the bearing shell is accommodated in the coupling member so as to be pivotable about its longitudinal axis and perpendicular to said axis.

2. The connecting assembly according to claim 1, wherein the axis is defined by the form-fitting cooperation of a cylindrical projection, which is formed at the free front end symmetrically on both sides of the hinged lever, with a recess correspondingly formed in the bearing shell.

3. The connecting assembly according to claim 1, wherein the adjustment point is formed as one of a bearing bolt and a bearing bushing and wherein the bearing shell supports the adjustment point so as to be pivotable about the axis of the bearing bolt or bearing bushing.

4. The connecting assembly according to claim 1, wherein the bearing shell is formed by two bearing halves of a plastics material, which together form a bearing portion for rotatably mounting the adjustment point about said axis.

5. The connecting assembly according to claim 4, wherein the two bearing halves are of identical shape and are locked together.

6. The connecting assembly according to claim 4, wherein the two bearing halves and the coupling member are configured such that the two bearing halves can be respectively inserted into the coupling member perpendicular to the longitudinal axis of the coupling member via an insertion opening laterally formed in the coupling member.

7. The connecting assembly according to claim 4, wherein the coupling member is provided with a receptacle extending in longitudinal direction of the coupling member in which the bearing shell is positively accommodated towards the longitudinal axis of the coupling member and secured in axial direction, wherein the receptacle, which is open at the upper end, serves for an engagement of the adjustment point in the bearing shell.

8. The connecting assembly according to claim 6, wherein a profile of the bearing shell formed by the two bearing halves is formed corresponding to the profile of the insertion opening and wherein stops are formed in said coupling member and at the two bearing halves, which define in cooperation with each other the position of the bearing portion for rotatably mounting the adjustment point in the bearing shell.

9. The connecting assembly according to claim 1, further comprising a base which is fixedly connected or fixedly connectable to the hinged member and is configured for a releasable connection to the coupling member.

10. The connecting assembly according to claim 9, wherein form-fitting elements are formed at the lower end of the coupling member and wherein correspondingly shaped interlocking elements are formed on that side of the base facing the coupling member, wherein a receptacle is formed in the base or at a lower end of the coupling member, so that the coupling member together with the bearing shell received therein and the adjustment point mounted therein can be brought into engagement with the base in a first rotational position and can be transferred into a second rotational position by rotation of the coupling member with the hinged lever about a longitudinal axis thereof, in which the form-fitting elements or the coupling piece are engaged with the base.

11. The connecting assembly according to claim 1, wherein a plurality of locking projections protrude in radial direction from the lower end of the coupling member and wherein the receptacle in the base comprises at least one diametrically extending insertion opening, wherein side walls of the receptacle form bearing portions for abutment with the form-fitting locking elements of the coupling member.

12. The connecting assembly according to claim 10, wherein securing projections are formed on a side of the base facing the coupling member, which project radially into the receptacle and secure the coupling member in the base in axial direction.

13. The connecting assembly according to claim 9, wherein a circumferential bearing surface is formed at an upper edge of the base for supporting an end-side elastic sealing ring, which is clamped between the coupling member and the base for accomplishing a sealing effect and for compensation of tolerances, when the coupling member is connected to the base.

14. The connecting assembly according to claim 13, wherein the sealing ring is provided at the other end of a sealing flap and is formed as a bead, wherein the sealing flap surrounds the coupling member and the front end of the hinged lever in a hood-shaped or dome-like manner.

15. The connecting assembly according to claim 14, wherein the sealing flap is formed rotationally symmetrical and wherein two circumferential sealing lips protrude from a peripheral wall thereof in radial direction, between which a gap for receiving the edge of a mounting opening is formed.

16. A driving device for a hinged member of a motor vehicle, comprising:
an electric motor coupled via a reduction gear to a hinged lever for adjusting said hinged lever along an adjustment path; and
a connecting assembly for coupling a front free end of the hinged lever to a base, which is fixedly connected or fixedly connectable with said hinged member to be adjusted; wherein
an adjustment point is formed at the front free end of the hinged lever;
said connecting assembly comprising:
a coupling member which is configured to be connected to the hinged member, and
a bearing shell, which is positively accommodated in the coupling member and pivotally supports the adjustment point, wherein
the adjustment point is supported in the bearing shell so as to be pivotable about an axis perpendicular to the longitudinal axis of the hinged lever and
the bearing shell is accommodated in the coupling member so as to be pivotable about its longitudinal axis and perpendicular to said axis;
said base being fixedly connected or fixedly connectable to the hinged member and
being configured for a releasable connection to the coupling member.

17. The driving device according to claim 16, wherein the coupling member is provided with a receptacle extending in longitudinal direction of the coupling member in which the bearing shell is positively accommodated towards the longitudinal axis of the coupling member and secured in axial direction, wherein the receptacle is open at the upper end serves for an engagement of the adjustment point in the bearing shell.

18. The driving device according to claim 17, wherein form-fitting elements are formed at the lower end of the coupling member and wherein correspondingly shaped interlocking elements are formed on that side of the base facing the coupling member, wherein a receptacle is formed in the base or at a lower end of the coupling member, so that the coupling member together with the bearing shell received therein and the adjustment point mounted therein can be brought into engagement with the base in a first rotational position and can be transferred into a second rotational position by rotation of the coupling member with the hinged lever about a longitudinal axis thereof, in which the form-fitting elements or the coupling piece are engaged with the base.

19. The driving device according to claim 17, wherein the hinged member is a pivotable hinged window of a motor vehicle.

20. The connecting assembly according to claim 1, wherein the axis is defined by a form-fitting cooperation of a cylindrical recess with a protrusion correspondingly formed in the bearing shell.

21. The connecting assembly according to claim 1, wherein the hinged member is a pivotable hinged window of a motor vehicle.
